(19) United States
(12) Patent Application Publication
(10) Pub. No.: US 2019/0188566 A1
(43) Pub. Date: Jun. 20, 2019

(54) REWARD AUGMENTED MODEL TRAINING

(71) Applicant: GOOGLE LLC, Mountain View, CA (US)

(72) Inventors: Michael Schuster, Mountain View, CA (US); Samuel Bengio, Mountain View, CA (US); Navdeep Jaitly, Mountain View, CA (US); Zhifeng Chen, Mountain View, CA (US); Dale Eric Schuurmans, Mountain View, CA (US); Mohammad Norouzi, Mountain View, CA (US); Yonghui Wu, Mountain View, CA (US)

(21) Appl. No.: 16/328,207

(22) PCT Filed: Aug. 25, 2017
(86) PCT No.: PCT/US17/48529

§ 371 Date: Feb. 25, 2019

Related U.S. Application Data
(60) Provisional application No. 62/379,705, filed on Aug. 25, 2016.

(51) Int. Cl. G06N 3/08; G06N 20/00

(52) U.S. Cl. CPC G06N 3/08; G06N 20/00

(57) ABSTRACT

A method includes obtaining data identifying a machine learning model to be trained to perform a machine learning task, the machine learning model being configured to receive an input example and to process the input example in accordance with current values of a plurality of model parameters to generate a model output for the input example; obtaining initial training data for training the machine learning model, the initial training data comprising a plurality of training examples and, for each training example, a ground truth output that should be generated by the machine learning model by processing the training example; generating modified training data from the initial training data; and training the machine learning model on the modified training data.

### CROSS-REFERENCE TO RELATED APPLICATION

This application claims priority to U.S. Provisional Application Ser. No. 62/379,705, filed on Aug. 25, 2016. The disclosure of the prior application is considered part of and is incorporated by reference in the disclosure of this application.

### BACKGROUND

This specification relates to training machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

Some neural networks are recurrent neural networks. A recurrent neural network is a neural network that receives an input sequence and generates an output sequence from the input sequence. In particular, a recurrent neural network uses some or all of the internal state of the network after processing a previous input in the input sequence in generating an output from the current input in the input sequence.

### SUMMARY

This specification describes how a system implemented as computer programs on one or more computers in one or more locations can train a machine learning model to perform a machine learning task, e.g., a structured prediction machine learning task.

In general, one innovative aspect may be embodied in a method for training a machine learning model. The method includes: obtaining data identifying a machine learning model to be trained to perform a machine learning task, the machine learning model being configured to receive an input example and to process the input example in accordance with current values of a plurality of model parameters to generate a model output for the input example; obtaining initial training data for training the machine learning model, the initial training data comprising a plurality of training examples and, for each training example, a ground truth output that should be generated by the machine learning model by processing the training example; generating modified training data from the initial training data, comprising, for each of one or more of the training examples in the initial training data: generating an auxiliary output for the training example from the ground truth output for the training example by selecting from a plurality of candidate auxiliary outputs based on, for each of the plurality of candidate auxiliary outputs, a respective measure of quality of the candidate auxiliary output relative to the ground truth output for the training example, and replacing the ground truth output for the training example with the auxiliary output for the training example; and training the machine learning model on the modified training data. The machine learning task can be a structured output prediction task.

In some implementations, training the machine learning model on the modified training data may include training the machine learning model to generate model outputs for the training examples that match the auxiliary outputs for the training examples using a gradient descent training technique.

In some other implementations, training the machine learning model on the modified training data may include training the machine learning model using maximum likelihood training.

The measure of quality of the candidate auxiliary output relative to the ground truth output may be a value of a task reward function for the machine learning task for the candidate auxiliary output. The machine learning task may be a task in which the machine learning model generates an output that is a sequence of tokens, and the task reward function is a negative edit distance between the ground truth output and the candidate auxiliary output.

In some implementations, the machine learning task is a machine translation task, and the task reward function is a BLEU score for the candidate auxiliary output.

In some implementations, the machine learning task is a speech recognition task, and the task reward function is a negative word error rate for the candidate auxiliary output.

In some implementations, the machine learning task is an image masking task, and the task reward function is based on (i) a union of pixels that are masked in the candidate auxiliary output and pixels that are masked in the ground truth output and (ii) an intersection of pixels that are masked in the candidate auxiliary output and pixels that are masked in the ground truth output.

Selecting from the plurality of candidate auxiliary outputs may include: sampling a candidate auxiliary output from the plurality of candidate auxiliary outputs in accordance with a score distribution over the plurality of candidate auxiliary outputs, wherein the score for each of the candidate auxiliary outputs in the score distribution is based on the measure of quality of the candidate auxiliary output relative to the ground truth output for the training example. The score for each of the candidate outputs may be based on the measure of quality scaled by a temperature hyper-parameter that controls a concentration of the score distribution. The score for each of the candidate outputs may be proportional to the scaled measure of quality exponentiated. Sampling the candidate output may include: sampling the candidate output using stratified sampling and/or importance sampling.

Particular embodiments of the subject matter described in this specification can be implemented so as to realize one or more of the following advantages. The subject matter described in this specification is generally directed to a training scheme for structured output prediction that incorporates task reward optimization into the training of a machine learning model. A task reward for an output is defined as its similarity to a ground truth output for an input. Conventional approaches that use only maximum likelihood or other conventional objectives and ignore the task reward during training are incapable of discerning between alternative incorrect outputs given a training input, e.g., all alternative outputs are equally penalized, whether near or far from the ground truth target. By incorporating a task reward function into the training, the training scheme provides improvements over existing techniques as it results in better performing machine learning models after training, i.e., models that perform better on a task because they can generate outputs that score better on the task reward function. In addition, the training scheme trains the machine learning models using modified training data that includes auxiliary outputs sampled from a stationary distribution instead of a non-stationary distribution that evolves over time, i.e., that changes during the course of the training, e.g., a model distribution that depends on the values of the parameters of the model. By sampling auxiliary outputs from a stationary distribution that does not depend on time, once the set of auxiliary outputs has been sampled, the same set of auxiliary outputs can be used to train all training examples without the need to sample new sets of auxiliary outputs during training. As a result, the training scheme incorporates the task reward function in a computationally-efficient manner and systems that train the machine learning model can use less of their storage capacity, reducing system complexity and shortening the training time while achieving the same or better results compared to existing techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example of a machine learning system.

FIG. 2 is a flow diagram of an example process for training a machine learning model to perform a machine learning task.

FIG. 3 is a flow diagram of an example process for generating modified training data from initial training data.

Like reference numbers and designations in the various drawings indicate like elements.

### DETAIL DESCRIPTION

This specification describes how a system, e.g., a machine learning system, implemented as computer programs on one or more computers in one or more locations can train a machine learning model to perform a machine learning task, e.g., a structured prediction machine learning task. Given inputs x, a structured prediction machine learning task involves predicting outputs y that are structured objects rather than scalar discrete values or real values. For example, a natural language processing task such as a text to part of speech task that involves translating a sentence in natural language into a syntactic representation such as a parse tree is a structured prediction machine learning task. Other structured prediction machine learning tasks may include a speech recognition task, machine translation task, or an image masking task.

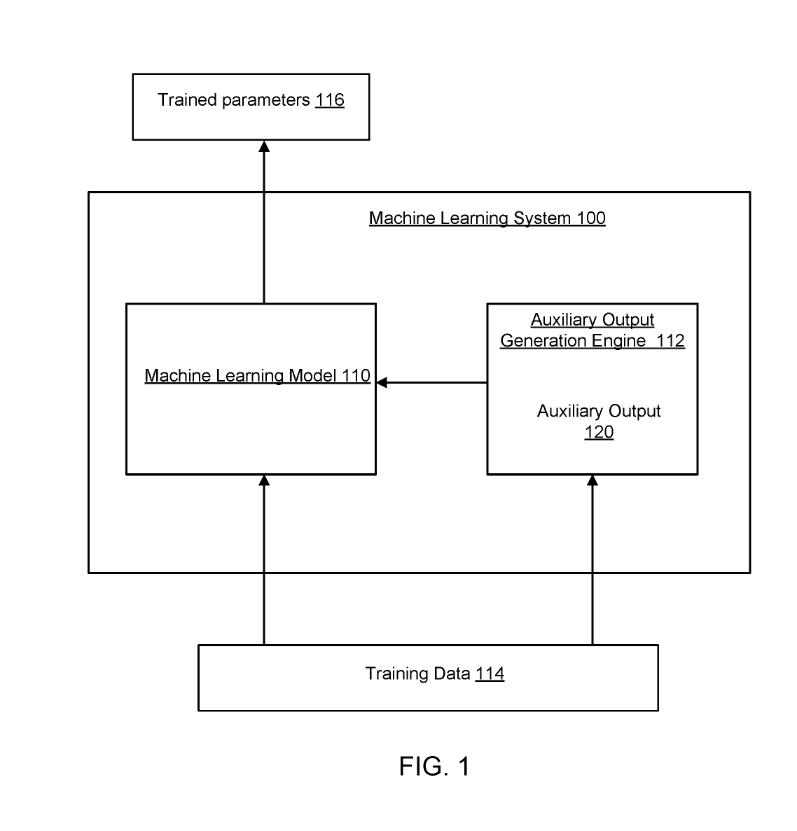

FIG. 1 is a block diagram of an example of a machine learning system 100. The machine learning system 100 is an example of a system implemented as computer programs on one or more computers in one or more locations in which the systems, components, and techniques described below are implemented.

The machine learning system 100 is configured to train a machine learning model 110 on a machine learning task. The machine learning model 110 is a parametric model having multiple parameters. The machine learning model 110 can receive an input and generate an output, e.g., a predicted output, based on the received input and on values of the parameters of the model 110.

In some cases, the machine learning model 110 is a deep machine learning model that employs multiple layers of operations to generate an output for a received input. For example, a deep neural network is a deep machine learning model that includes an output layer and one or more hidden layers that each apply a non-linear transformation to a received input to generate an output.

In general, the machine learning system 100 trains the machine learning model 110 on a particular task by adjusting the values of the parameters of the machine learning model 110 to optimize performance of the model 110 on the particular task, e.g., by optimizing an objective function.

To train the machine learning model 110 on a particular task, the machine learning system 100 is configured to obtain initial training data 114. The initial training data 114 includes training examples and, for each training example, a ground truth output that should be generated by the machine learning model by processing the training example.

The system 100 then generates modified training data from the initial training data and trains the machine learning model 110 on the modified training data, i.e., instead of on the obtained initial training data.

In particular, the system 100 can generate the modified training data using an auxiliary output generation engine 112. For each of one or more of the training example in the initial training data 114, the engine 112 generates an auxiliary output 120 for the training example from the ground truth output for the training example.

In particular, for a given training example and a corresponding ground truth output for the training example, the engine 112 selects a candidate auxiliary output from a set of candidate auxiliary outputs. In some cases, the set of candidate auxiliary outputs is a set of all outputs that could be generated by the model 110. In some other cases, the set of candidate auxiliary outputs is a subset of the set of all outputs that could be generated by the model 110.

The engine 112 selects a candidate auxiliary output from the set of candidate auxiliary outputs based on, for each of the candidate auxiliary outputs, a respective measure of quality of the candidate auxiliary output relative to the ground truth output for the training example. Generally, the measure of quality of the candidate auxiliary output relative to the ground truth output is a value of a task reward function for the machine learning task for the auxiliary output.

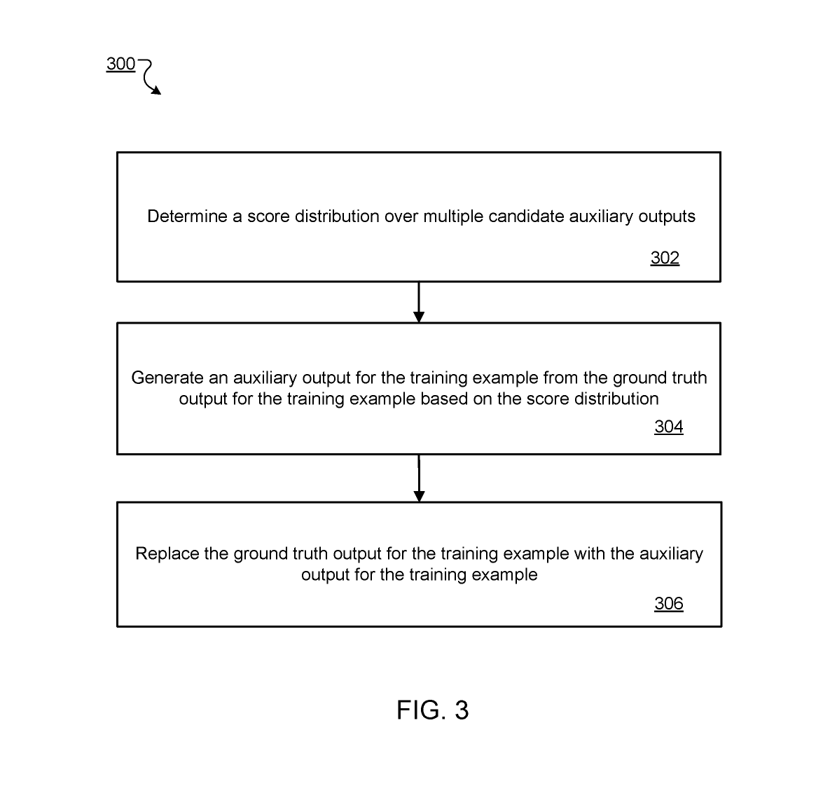

To select a candidate auxiliary output, the engine 112 samples a candidate auxiliary output from the candidate auxiliary outputs in accordance with a score distribution over the candidate auxiliary outputs. The score for each of the candidate auxiliary outputs in the score distribution is based on the measure of quality of the candidate auxiliary output relative to the ground truth output for the training example. The score distribution is described in more detail below with reference to FIG. 3.

The engine 112 can sample a candidate auxiliary output using a sampling technique that is appropriate for the distribution and the measure of quality. For example, the engine 112 may use stratified sampling and/or importance sampling.

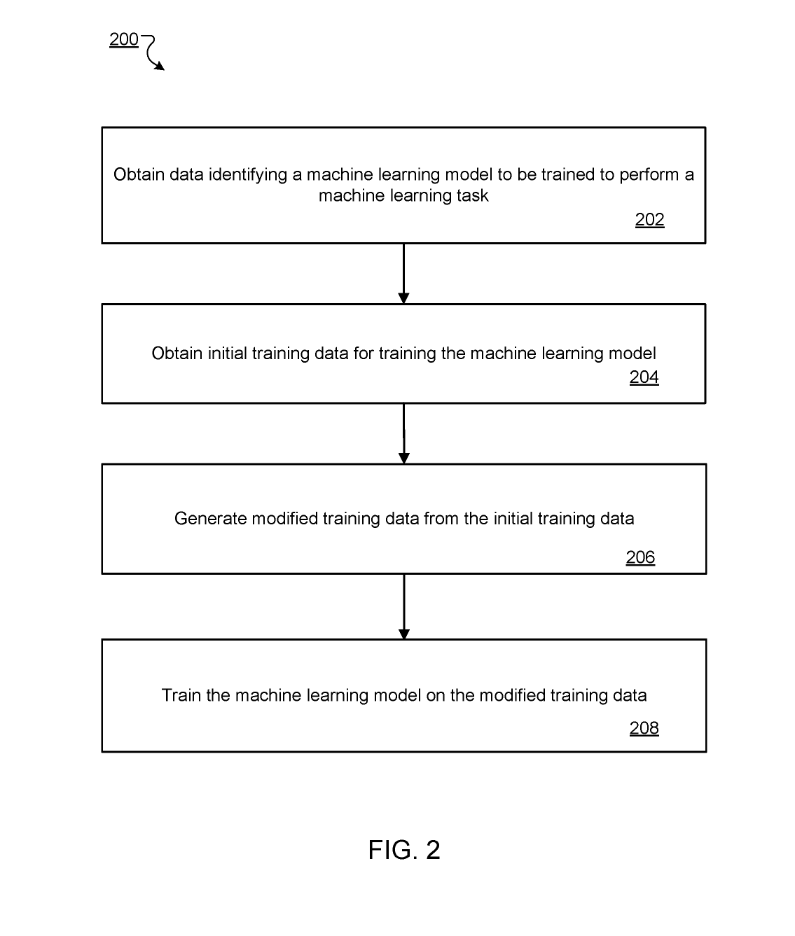

After the engine 112 has sampled a candidate auxiliary output for each training example, the system 100 replaces the ground truth output for the training example with the candidate auxiliary output. The system 100 then uses the candidate auxiliary outputs and training examples as modified training data to train the model 110 on the machine learning task. Given the modified training data, the system 100 trains the model 110 to determine trained parameter values 116 that optimize the objective function. Training the model 110 on the machine learning task is described in more detail below with reference to FIG. 2.

FIG. 2 is a flow diagram of an example process for training a machine learning model to perform a machine learning task. For convenience, the process 200 will be described as being performed by a system of one or more computers located in one or more locations. For example, a machine learning system, e.g., the machine learning system 100 of FIG. 1, appropriately programmed in accordance with this specification, can perform the process 200.

The system obtains data identifying a machine learning model to be trained to perform a machine learning task (step 202).

The machine learning model is a parametric model having multiple parameters. The machine learning model is configured to receive an input example and to process the input example in accordance with current values of a plurality of model parameters to generate a model output for the input example.

In some cases, the machine learning model is a deep machine learning model that employs multiple layers of the model to generate an output for a received input. For example, a deep neural network is a deep machine learning model that includes an output layer and one or more hidden layers that each apply a non-linear transformation to a received input to generate an output.

Next, the system obtains initial training data for training the machine learning model (step 204). The initial training data includes multiple examples and, for each training example, a corresponding ground truth output. The ground truth output for a given training example is an output that should be generated by the machine learning model by processing the training example. For example, the initial training data can include a set of N training example-ground truth output pairs

[symbol]

≡{x⁽ⁱ⁾,y*⁽ⁱ⁾)}ᵢ₌₁^{N},

where x is a training example, and y* is a ground truth output for the training example.

The system then generates modified training data from the initial training data (step 206).

For example, the system generates modified training data by generating, for each of one or more of the training examples in the initial training data, an auxiliary output for the training example from the ground truth output for the training example. Generating modified training data from the initial training data is described in more detail below with reference to FIG. 3.

The system then trains the machine learning model on the modified training data (step 208). In general, given the modified training data, the system trains the machine learning model on a particular task by adjusting the values of the parameters of the machine learning model to optimize performance of the model on the particular task, e.g., by optimizing an objective function.

In some implementations, the objective function can take the following form:

$${RAML}_{} ( θ ; τ , ) = {\sum }_{( x , {y}^{*} ) ∈} \{ - q ( y \vert {y}^{*} ; τ ) log {p}_{θ} ( y \vert x ) \} , \qquad ( 1 )$$

where for each training example, q(y|y*; [symbol] ) is a score distribution over multiple candidate auxiliary outputs for the training example, e.g., over all of the possible outputs that can be generated by the model for the training example. Given the ground truth output y* for the training example and a temperature parameter [symbol] that serves as a hyper-parameter that controls a concentration of the score distribution, the score distribution assigns a score to a candidate auxiliary output y in the a set of candidate auxiliary outputs y based on the measure of quality of the candidate auxiliary output relative to the ground truth output of the training example. log pₑ(y|x) represents a log-likelihood of the candidate auxiliary output y given the training example x and given the current values of the parameters θ of the machine learning model.

Given the modified training data, the system can train the machine learning model on a given training example by following a conventional maximum likelihood training process except that the ground truth output for the given training example is replaced by a corresponding auxiliary output.

For example, the gradient of the objective function in the maximum likelihood training process can take the form:

∇_{θ} [symbol] _{RAML}(θ;τ)= [symbol] _{q(y|y*;τ)}[−∇_{θ} log p_{θ}(y|x)] (2)

Given a mini-batch of training examples, the system can estimate the gradient ∇_{θ} [symbol] _{RAML} (θ; τ) using stochastic gradient descent. In particular, for each training example in the mini-batch, the system first samples an auxiliary output y for the training example using the ground truth output y* for the training example according to the score distribution q(y|y*;τ) and then optimizes log-likelihood on the sampled auxiliary outputs, e.g., by following the mean gradient for the training examples in the mini batch.

The score distribution q(y|y*;τ) incorporates a task reward function and is described in more detail with reference to FIG. 3. Generally, however, the distribution q(y|y*;τ) does not change during the training and hence is called a stationary distribution. Therefore, all auxiliary outputs for all ground truth outputs can be sampled before the training starts and no more sampling from the distribution is required during the training. While other approaches for incorporating a task reward into training, e.g., reinforcement learning-based approaches, optimize the objective as expected reward, which involves sampling from a model distribution that is evolving over time (i.e. non-stationary distribution) and therefore require the sampling of multiple sets of auxiliary outputs at multiple times during the training, the described techniques can sample only one set of auxiliary outputs and use this set for the entire training process. Therefore, this training technique is computationally efficient as it reduces training time and computer resources (e.g., storage space) needed for the training process.

FIG. 3 is a flow diagram of an example process for generating modified training data from initial training data. For convenience, the process 300 will be described as being performed by a system of one or more computers located in one or more locations. For example, a machine learning system, e.g., the machine learning system 100 of FIG. 1, appropriately programmed in accordance with this specification, can perform the process 300.

The system determines a score distribution over a set of candidate auxiliary outputs for training examples in the initial training data (step 302). In some cases, the set of candidate auxiliary outputs is a set of all outputs that could be generated by the machine learning model that is being trained by the system. In some other cases, the set of candidate auxiliary outputs is a subset of the set of all outputs that could be generated by the model. The score for each of the candidate auxiliary outputs in the score distribution is based on the measure of quality of the candidate auxiliary output relative to the ground truth output for the training example.

Generally, the measure of quality of a candidate auxiliary output relative to the ground truth output is a value of a task reward function for the machine learning task for the candidate auxiliary output.

For example, if the machine learning task is a task in which the machine learning model generates an output that is a sequence of tokens, e.g., a natural language processing task, a speech recognition task, or a machine translation task, the task reward function may be a negative edit distance between the ground truth output and the candidate auxiliary output.

As another example, if the machine learning task is a machine translation task, the task reward function may be a BLEU score for the candidate auxiliary output.

As another example, if the machine learning task is a speech recognition task, the task reward function may be a negative word error rate for the candidate auxiliary output.

As another example, if the machine learning task is an image masking task, the task reward function may be based on (i) a union of pixels that are masked in the candidate auxiliary output and pixels that are masked in the ground truth output and (ii) an intersection of pixels that are masked in the candidate auxiliary output and pixels that are masked in the ground truth output.

In some cases, the score may be based on the measure of quality scaled by a temperature hyper-parameter that controls a concentration of the score distribution. The temperature hyper-parameter may be a non-negative parameter. Further, the score may be proportional to the scaled measure of quality after it has been exponentiated.

For example, in some implementations, the score distribution can be expressed as follows:

$$q ( y \vert {y}^{*} ; τ ) = \frac{1}{Z ( {y}^{*} , τ )} exp \{ r ( y , {y}^{*} ) / τ \} ,$$

where y* is a ground truth output, y is a candidate auxiliary output that belongs to a set of candidate auxiliary outputs [symbol] , r(y, y*) is a task reward function that determines the measure of quality of the candidate auxiliary output y relative to the ground truth output y*, [symbol] is a temperature parameter serves as a hyper-parameter that controls a concentration of the score distribution, and where

Z(y*,τ)=Σ_{yϵy}exp{r(y,y*)/τ}.

After determining the score distribution, the system generates, for each of one or more of the training examples in the initial training data, an auxiliary output for the training example from the ground truth output for the training example based on the score distribution (step 304).

In particular, the system samples a candidate auxiliary output from the set of candidate auxiliary outputs in accordance with the score distribution.

The system can sample an output using a sampling technique that is appropriate for the score distribution and the measure of quality.

For example, the system may sample a candidate auxiliary output using stratified sampling. In stratified sampling, the system first selects a distance metric between two candidate auxiliary outputs. For example, for machine learning task in which the machine learning model generates an output that is a sequence of tokens (e.g., a natural language processing task, a speech recognition task, or a machine translation task), a distance metric can be Hamming distance or edit distance. In such cases, the task reward function r(y,y*) can be a negative of the selected distance between the ground truth output and the model output generated by the machine learning model. The system then samples auxiliary outputs according to the distribution q(y|y*;τ) with the task reward function by using importance sampling. A proposal distribution of the importance sampling process can be defined by the above distance metric.

After generating, for each training example, an auxiliary output, the system replaces the ground truth output for the training example with the auxiliary output for the training example (step 306). The training examples and auxiliary outputs are then used as modified training data to train the machine learning model.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
obtaining data identifying a machine learning model to be trained to perform a machine learning task, the machine learning model being configured to receive an input example and to process the input example in accordance with current values of a plurality of model parameters to generate a model output for the input example;
obtaining initial training data for training the machine learning model, the initial training data comprising a plurality of training examples and, for each training example, a ground truth output;
generating modified training data from the initial training data, comprising, for each of one or more of the training examples in the initial training data:
generating an auxiliary output for the training example from the ground truth output for the training example by selecting from a plurality of candidate auxiliary outputs based on, for each of the plurality of candidate auxiliary outputs, a respective measure of the similarity of the candidate auxiliary output to the ground truth output for the training example, and
replacing the ground truth output for the training example with the auxiliary output for the training example; and
training the machine learning model on the modified training data.

2. The method of claim 1, wherein the machine learning task is a structured output prediction task.

3. The method of claim 1, wherein training the machine learning model on the modified training data comprises training the machine learning model to generate model outputs for the training examples that match the auxiliary outputs for the training examples using a gradient descent training technique.

4. The method of claim 3, wherein training the machine learning model on the modified training data comprises training the machine learning model using maximum likelihood training.

5. The method of claim 1, wherein the measure of the similarity of the candidate auxiliary output to the ground truth output is a value of a task reward function for the machine learning task for the candidate auxiliary output.

6. The method of claim 5, wherein the machine learning task is a task in which the machine learning model generates an output that is a sequence of tokens, and wherein the task reward function is a negative edit distance between the ground truth output and the candidate auxiliary output.

7. The method of claim 5, wherein the machine learning task is a machine translation task, and wherein the task reward function is a BLEU score for the candidate auxiliary output.

8. The method of claim 5, wherein the machine learning task is a speech recognition task, and wherein the task reward function is a negative word error rate for the candidate auxiliary output.

9. The method of claim 5, wherein the machine learning task is an image masking task, and wherein the task reward function is based on (i) a union of pixels that are masked in the candidate auxiliary output and pixels that are masked in the ground truth output and (ii) an intersection of pixels that are masked in the candidate auxiliary output and pixels that are masked in the ground truth output.

10. The method of claim 1, wherein selecting from the plurality of candidate auxiliary outputs comprises:
sampling a candidate auxiliary output from the plurality of candidate auxiliary outputs in accordance with a score distribution over the plurality of candidate auxiliary outputs, wherein the score for each of the candidate auxiliary outputs in the score distribution is based on the measure of the similarity of the candidate auxiliary output to the ground truth output for the training example.

11. The method of claim 10, wherein the score distribution is a stationary distribution.

12. The method of claim 10, wherein the score for each of the candidate outputs is based on the measure of the similarity scaled by a temperature hyper-parameter that controls a concentration of the score distribution.

13. The method of claim 12, wherein the score for each of the candidate auxiliary outputs is proportional to the scaled measure of the similarity exponentiated.

14. The method of claim 9, wherein sampling the candidate output comprises:
sampling the candidate output using stratified sampling.

15. The method of claim 9, wherein sampling the candidate auxiliary output comprises:
sampling the candidate output using importance sampling.

16. A system comprising one or more computers and one or more storage devices storing instructions that, when executed by the one or more computers, cause the one or more computers to perform operations comprising:
obtaining data identifying a machine learning model to be trained to perform a machine learning task, the machine learning model being configured to receive an input example and to process the input example in accordance with current values of a plurality of model parameters to generate a model output for the input example;
obtaining initial training data for training the machine learning model, the initial training data comprising a plurality of training examples and, for each training example, a ground truth output;
generating modified training data from the initial training data, comprising, for each of one or more of the training examples in the initial training data:
generating an auxiliary output for the training example from the ground truth output for the training example by selecting from a plurality of candidate auxiliary outputs based on, for each of the plurality of candidate auxiliary outputs, a respective measure of the similarity of the candidate auxiliary output to the ground truth output for the training example, and
replacing the ground truth output for the training example with the auxiliary output for the training example; and
training the machine learning model on the modified training data.

17. A non-transitory computer storage medium encoded with instructions that, when executed by one or more computers, cause the one or more computers to perform operations comprising:
obtaining data identifying a machine learning model to be trained to perform a machine learning task, the machine learning model being configured to receive an input example and to process the input example in accordance with current values of a plurality of model parameters to generate a model output for the input example;
obtaining initial training data for training the machine learning model, the initial training data comprising a plurality of training examples and, for each training example, a ground truth output;
generating modified training data from the initial training data, comprising, for each of one or more of the training examples in the initial training data:
generating an auxiliary output for the training example from the ground truth output for the training example by selecting from a plurality of candidate auxiliary outputs based on, for each of the plurality of candidate auxiliary outputs, a respective measure of the similarity of the candidate auxiliary output to the ground truth output for the training example, and
replacing the ground truth output for the training example with the auxiliary output for the training example; and
training the machine learning model on the modified training data.

18. The system of claim 16, wherein training the machine learning model on the modified training data comprises training the machine learning model to generate model outputs for the training examples that match the auxiliary outputs for the training examples using a gradient descent training technique.

19. The system of claim 16, wherein training the machine learning model on the modified training data comprises training the machine learning model using maximum likelihood training.

20. The non-transitory computer storage medium of claim 17, wherein selecting from the plurality of candidate auxiliary outputs comprises:
sampling a candidate auxiliary output from the plurality of candidate auxiliary outputs in accordance with a score distribution over the plurality of candidate auxiliary outputs, wherein the score for each of the candidate auxiliary outputs in the score distribution is based on the measure of the similarity of the candidate auxiliary output to the ground truth output for the training example.
